(19) United States
(12) Patent Application Publication
(10) Pub. No.: US 2004/0123268 A1
(43) Pub. Date: Jun. 24, 2004

(54) Program code distribution

(76) Inventors: Steven J. Lundberg, Shelby Township, MI (US); James W. Johnston, Rochester Hills, MI (US); Stephen V. Parker, Chesterfield, MI (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/326,196

(22) Filed: Dec. 20, 2002

(51) Int. Cl. G06F 9/44

(52) U.S. Cl. 717/103; 717/115

(57) ABSTRACT

Program code is distributed to various servers in and beyond a network by the use of a configuration management program in combination with a build program. The build program automatically compiles the code, builds the code into suitable files, and converts the code to the proper protocol for transmission to the different servers in the network. Preferably, both programs and their interface are located on the same server so as to minimize errors. The invention greatly reduces the time and errors involved in distributing new applications, “bug fixes” and other program changes to the network.

This invention relates to computer systems, methods and networks. More particularly, this invention relates to computer methods and systems for distributing in such networks program code, especially program changes.

In computer networks, including both private networks for businesses or institutions, and more widespread public networks, the distribution of program code such as program changes are needed frequently. Typical changes include “bug fixes”, enhancements, new applications, etc.

In the past, new code distribution in a network has been relatively time-consuming and expensive. Various processes such as extracting the code from storage, compiling, creating a “build” and distributing the code has been done manually.

A number of configuration management tools (“CM” tools”) are available for facilitating management of the software in a network, and particularly a network using multiple-platform equipment. Such CM tools have been used to assist in the making of program changes. One such configuration management tool is a program called “CCC/Harvest”, sold and maintained by Computer Associates Inc. Such software has been used frequently to assist in the preparation and storage of program change code, and in other software management tasks.

Nonetheless, the inventors have recognized that it still has been time-consuming to distribute program changes from such a management system to the various locations in the network where the changes are to be deployed.

For example, in the past it has been necessary to first manually extract the code from the repository in the configuration management system, then manually obtain any compilation which is necessary, manually create “build” files, manually convert the files to the necessary transmission protocol to send it to the destination servers, and manually notify the affected parties that the information has been distributed.

The inventors also have recognized a factor which not only increases the time required for the distribution, but also increases the possibility for error. That is, the various manual steps noted above often are performed on different servers. This gives added opportunity for the commission of errors which require more time to correct.

In view of the foregoing, it is an object of the present invention to provide a program code distribution method and system and software which eliminates or greatly alleviates the foregoing problems.

More particularly, it is an object of the invention to provide such a system and method in which the distribution of program code, and particularly program changes, in a network is both automatic and relatively fast and labor-free, and is relatively error-free.

It is another object of the invention to provide a computer-readable storage medium bearing the program needed for enabling the foregoing.

In accordance with the present invention, the foregoing objectives are satisfied by the provision of a combination of a configuration management program with a build tool which together performs the steps necessary to extract the code from the configuration management tool, process it, and distribute it in the network automatically.

In one embodiment, the invention includes an integration program in combination with a build program in the automatic distribution of the code.

Preferably, the programs are stored on a single server so that it is not necessary to increase the chance of errors by transfer between servers.

In a preferred embodiment of the invention, the build tool is an ANT build script utility, or a modified version thereof, which is a Java-based build tool readily available to the public.

Preferably, the configuration management program is one which has various different states or modes of operation. For example, the configuration management system can provide separate states providing a repository for code relating to development; for integration; for user acceptance testing; and production. An example of such a program is that sold under the name “CCC/Harvest”, which is further identified above.

The resulting automation of the distribution process greatly reduces the time and improves the quality of the product in distributing program code, and particularly program changes and additions. The foregoing and other embodiments and advantages will be described in or made apparent from the following description and drawings:

### In The Drawings

FIG. 1 is a schematic diagram illustrating the structure and operation of one embodiment of the invention;

FIG. 2 is another schematic diagram showing a portion of the structure of FIG. 1;

FIG. 3 is a schematic diagram illustrating certain features of the interface between two programs illustrated in FIGS. 1 and 2; and

FIG. 4 is a further flow chart illustrating certain features of the build program used in the invention.

### GENERAL DESCRIPTION

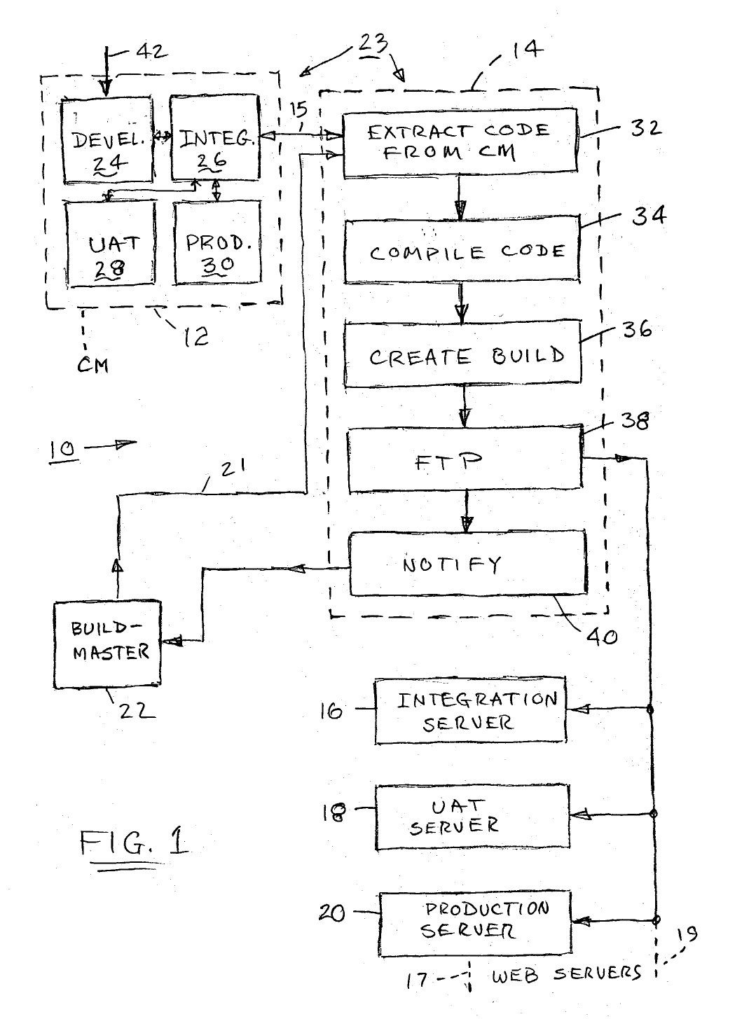

FIG. 1 shows a program code distribution system 10 which is made of two principal software programs 12 and 14, and other features and software to be described below.

Program 12 is a configuration management software program, such as the aforementioned CCC/Harvest program, or one of another of several known similar configuration management software programs.

The program 14 is a “build” program, such as the ANT build script utility which is available as freeware from Worldwide Web, or another such build program.

The build program 14 is interconnected as indicated at 15 with the configuration management program 12 so that the build program 14 operates automatically to distribute code from the configuration management program to a network including multiple servers at different locations, such as production server 20, as well as integration and user acceptance testing servers 16 and 18, and web servers (not shown in FIG. 1).

In using the system and method of the invention, first, the changed code is developed elsewhere and is delivered to the configuration management software 12 (“CM Tool”) as indicated at input line 42. The changed code is stored in a software source code repository 24 for the “development” state of the program.

Separate source code repositories are provided in three other “states” of the CM Tool; an integration state 26; a user acceptance testing state 28; and a production state 30. Other states also can be used, if desired.

When the code is extracted from the CM program in step 32, it is compiled, in step 34 (if necessary) and then a “build” is created at step 36. The build is then transported via FTP protocol, for transmission to various locations in the network, such as an integration server 16, a user acceptance testing service 18, and a production server 20. Later, after testing is complete, it is sent to the web servers for use.

After the integration step the new software is tested, and, when that step is complete, the build master 22 signals the CM program to move to the next state, the UAT state. When that is successfully tested, then the build master moves the build in the CM Tool, and the program changes are deployed.

The CM Tool program 12 thus is accessed sequentially to provide integration testing build change control, which is sent to the integration server 16; user acceptance testing which is sent to a UAT server 18; and then is sent to a production server 20 and to the web servers.

When each step of the process is complete, notification is sent to all of the locations affected by the changes and to the build master 22. The build master 22, for example, [uses] an ordinary computer terminal to issue the UDP command to start the build and deploy process in each of the CM States in the tool. The operator is known as a “build master”.

Preferably, both programs 12 and 14 are stored in a single “build” server indicated at 23 in FIG. 1, so that no code needs to be removed from the server and delivered to another server during the distribution process. This essentially eliminates another potential source of corruption of the code and also greatly speeds the processing and distribution of the changes.

In FIG. 1, dashed line 17 indicates that other servers can be added to the system, including web servers and other servers. Dashed line 19 indicates that the code can be distributed to the other servers in the network, and also can be transmitted out of the network to other servers outside the network.

### DETAILED DESCRIPTION

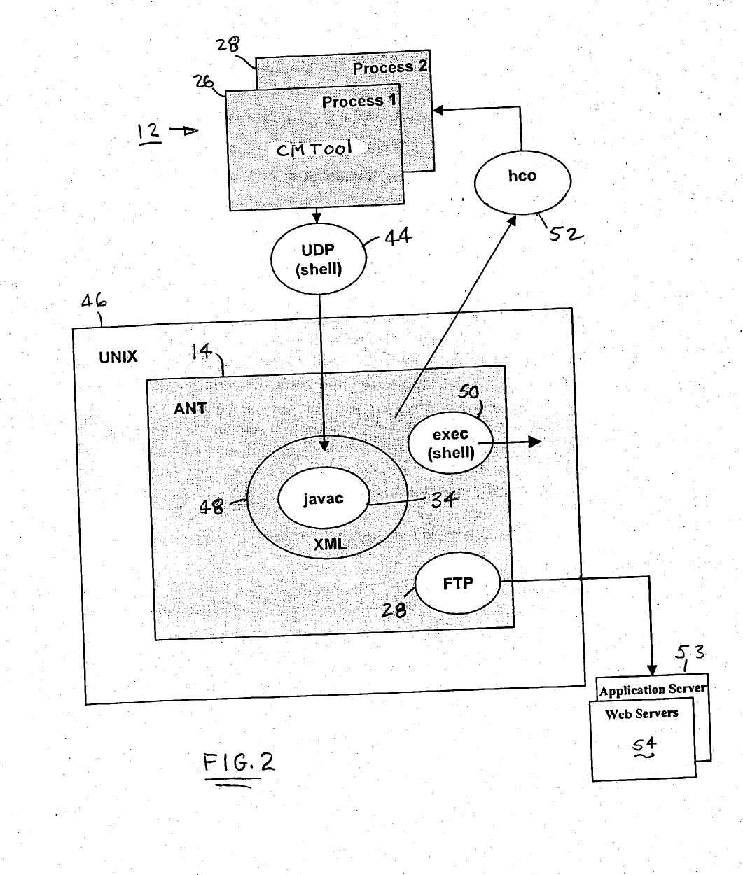

FIG. 2 is another schematic diagram illustrating a part of the system shown in FIG. 1.

The configuration management tool 12 is shown only in part, with only two stages 26 and 28 illustrated, for the purpose of simplification. It should be understood that stage 26 (“Process 1”) is the integration stage, and “Process 2” is the UAT stage 28 of FIG. 1. Other stages or “processes” can be selected instead in order to show the principles under discussion.

The ANT build module 14 is shown in its UNIX environment 16.

A User Defined Process (“UDP”) 44 is used to interface the ANT build module 14 with the CM Tool 12. The UDP 44 will be described in greater detail below.

Item 34 is the Java compiler, and item 48 indicates the XML language used in the compiler.

Element 50 illustrates a communication layer formed between the ANT build module and UNIX.

Element 28 corresponds to the same element shown in FIG. 1 which is used to convert the build to the FTP protocol for transmission in the network.

Item 54 schematically represents one or more web servers, which also are indicated in the lower right hand portion of FIG. 1. Item 52 collectively refers to application servers, such as the integration server 16, UAT server 18, and production server 20 of FIG. 1.

Referring to FIG. 2, the element 52 represents a command “hco” which is sent from the ANT build program to start a new process or state, such as Process 2, after Process 1 has been completed.

The command “hco” to pull code from the CM Tool State, is sent by the ANT build program after receiving a signal from the build master 22 (FIG. 1) over line 21.

Similarly, after the user acceptance testing process has been completed by the users, and the build is approved, another command signal “hco” is sent to the CMT 12 to start the next process or state, and so forth, until the build and deployment is completed.

It should be understood, however, that it is within the scope of the present invention to skip one or more of the stages of the operation described above for the CM tool, or to add to them, if further stages of operation are needed or desired.

For example, it is within the scope of this invention to proceed directly from the integration process to the production process, if it is necessary to deploy the code very quickly, without the testing facilitated by the other stages. Similarly, it is within the scope of this invention to add other stages to the total process of deployment of the code.

### UDP Interface

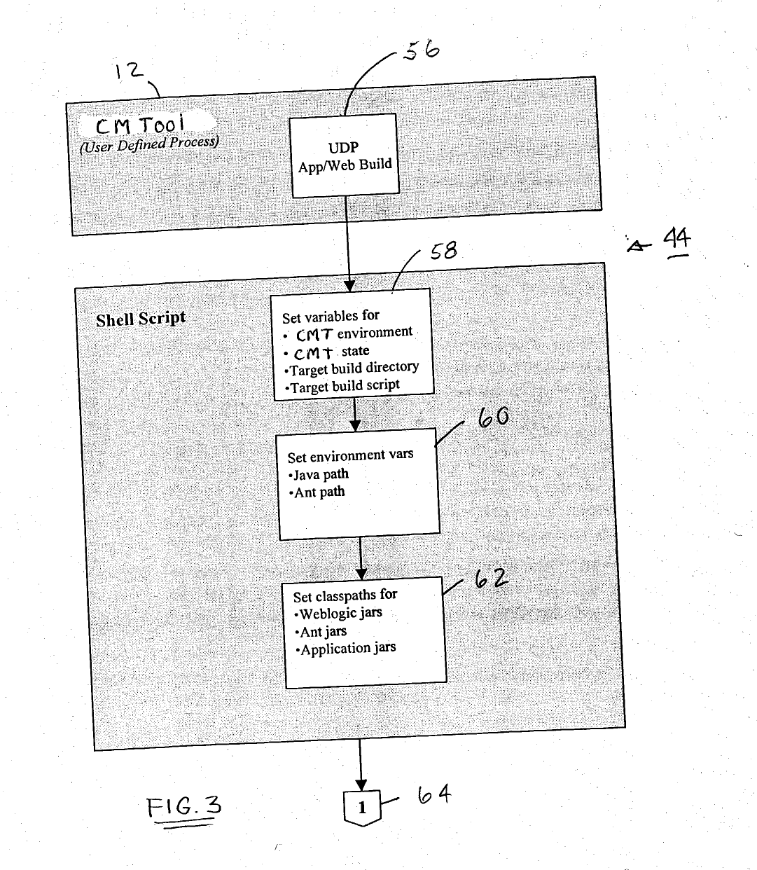

FIG. 3 is a schematic diagram explaining additional features of the UDP interface 44 which is used to couple the CM tool 12 to the build program 14 to automate the deployment steps as shown in FIG. 1.

Block 56 indicates that the UDP interface 44 is formed in the CM tool as a specific type of build, which can be selected by the build master from an array of different builds stored in the CM tool.

The shell script of the UDP includes programming to perform the functions indicated in block 58. That is, software to set the variables for the CM tool environment; the CM Tool state; a target build directory; and a target build script.

Block 60 indicates the further steps employed by the software in setting environment variables for the Java path and the ANT path.

Block 62 shows the additional functions performed in setting classpaths for Weblogic jars (Java archive files); ANT jars; and application jars.

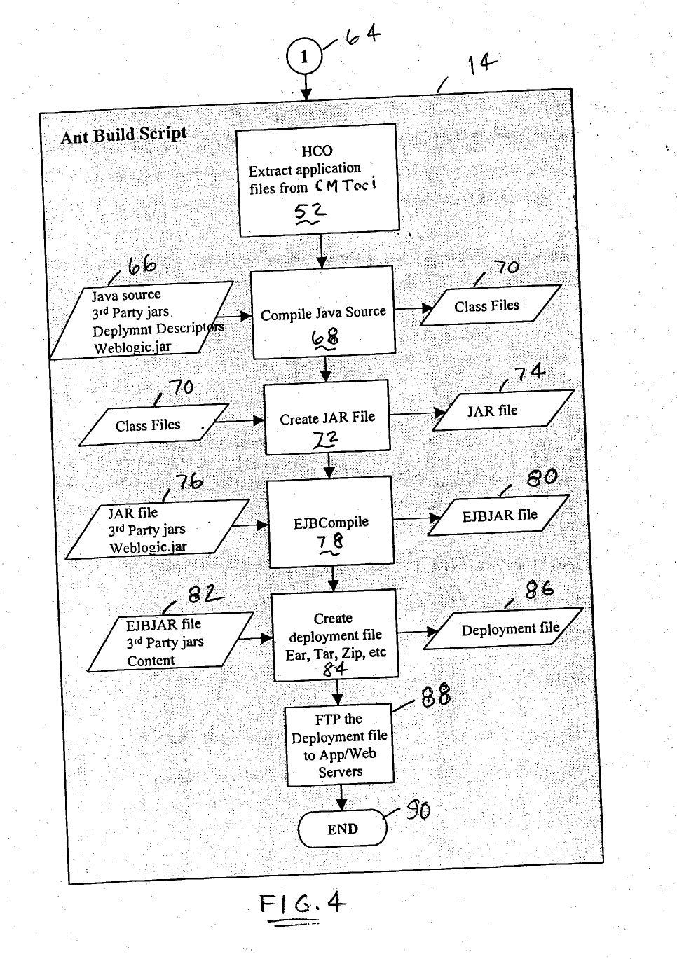

The process then exits at 64 to the flow chart shown in FIG. 4 which illustrates, in greater detail, the ANT build script.

### ANT Build Script

The flow chart in FIG. 4 corresponds generally to the flow chart in FIG. 1 for the ANT build script 14 but includes further details and additions.

Although a standard ANT build script can be obtained from the Internet as freeware and used in an embodiment of the invention, the script shown in FIG. 4 is enhanced. It is within the scope of this invention to make other enhancements or simplifications as desired.

The process starts with the receipt of the “hco” signal, from the build master 22 (FIG. 1), or elsewhere which extracts the application file codes from the CM tool, as indicated in block 52 (see FIG. 2).

The code from the CM tool is compiled as indicated at step 68, using a variety of source files indicated at 66. These source files include Java source; third party jars; deployment descriptors; and Weblogic jar.

The result of the compilation process is a set of class files 70. The class files 70 then are used at 72 to create a jar file 74.

The jar file 74 is used as a source 76, together with third party jars and Weblogic jar to perform an EJB Compile at 78 to produce an EJB jar file at 80. (“EJB” stands for Enterprise Java Beans).

The EJB is used, at 82, with third party jars and other content to create a deployment file in the form of a Ear Tar, Zip, etc., as indicated at 84. This creates a deployment file 86 which then is delivered to the next step indicated at 88 which deploys the code via FTP and sends the deployment file to the application or web servers. The process ends at 90.

### Alternative Embodiments

It should be understood that a variety of other build programs could be used in practicing the invention. For example, commercially available software, such as that sold under the name “Openmake” by Catalyst Systems Inc. can be used, as can a number of other known build tool programs.

Similarly, it should be understood that other configuration management tools can be used instead of CCC/Harvest. One example is called “PVCS” sold by Merant Company. Another is a program called “ClearCase” by Rationale Software.

Also available is “CVS Starbase” which is open source freeware available for use as a configuration management tool.

Other configuration management tools also can be used. In fact, as long as the software provides the integration feature, it is feasible for use in the invention. Of course, the testing features of the software are very highly desirable.

It also is possible to store all of the necessary software on one or more disks or in other computer-readable program storage media for use and sale or lease as a commercial product, and it is within the scope of the invention to do this.

### EXAMPLE

As an example of how the invention works, it will be assumed that a bug has been found in the software of the system and a “bug fix” therefore is needed.

Assume that one or more programmers creates one or more packages of software and calls them “bug fix 1234”. After this software has been approved by the build master, it is loaded into the development code repository of the CM Tool 12 (see FIG. 1). The changes are versioned controlled in the CM Tool repository, thus changing the version number of the software item included in the change package.

Next, again pursuant to an instruction from the build master, the code is moved into the integration state to start the build process. The build process described above using the ANT build module 14 and distribution to a desired destination then is performed as described above. At the end of the distribution, the parties, including the build master, are notified as indicated at 40 in FIG. 1.

When this happens, next the software developers test the software. When they have approved it, the build master then signals the CM tool to move to the next state, user acceptance testing 28. During the user acceptance testing process, the software is delivered for testing to the ultimate users. When they have completed testing and found the software acceptable, the build master, then again signals the CM tool to move the production state 30 which then again uses the ANT build software and creates the final production build software which is delivered to web servers, production servers, and, if desired, outside of the network as well for use in production.

It can be seen that the foregoing invention ably fulfills the objectives set forth above.

The use of a build software module together with a configuration management package greatly reduces the time and errors often created by the usual manual build process. Furthermore, by locating both the build process and the configuration management tool on the same server, additional sources of error and delay are eliminated.

Given the fact that many networks require frequent additions, bug fixes and other modifications, as frequently as several times an hour, the time and error savings by use of the invention are multiplied many times over during each day of its use.

The above description of the invention is intended to be illustrative and not limiting. Various changes or modifications in the embodiments described may occur to those skilled in the art. These can be made without departing from the spirit or scope of the invention.

1. A method for distributing program code in a computer network, said method comprising:
(a) storing said computer code in a configuration management tool repository;
(b) extracting said computer code from said repository; and
(c) delivering said code to a build tool program for processing said code and delivering said code to different locations in said network.

2. A method as in claim 1 in which said configuration management tool includes states for development, integration, user acceptance testing, and production, and including the steps of repeating said delivering step for each successive one of said stages utilized in the distribution process.

3. A method as in claim 1 in which said configuration management tool and said build tool are stored in a single server.

4. A method as in claim 1 in which said build tool is an ANT build script mechanism.

5. A method as in claim 1 in which said different locations comprise servers for integration, user acceptance testing, production, and includes web servers.

6. A method as in claim 1 including notifying parties at different locations in said network of the status of the build process at completion.

7. A method as in claim 1 including the steps of testing said code and then delivering said code to a plurality of servers at said locations.

8. A method as in claim 1 in which said build tool program comprises code for compiling, creating archive files, and transporting said files via FTP network protocol for transmission to remote servers.

9. A method as in claim 1 including the step of sending signals notifying network stations and a build master station when said delivering step is complete.

10. A system for distribution of program code in a computer network, said system comprising:
(a) a configuration management software tool having states for configuring application code for use in a network;
(b) a computer software build tool for processing and delivering said computer code to multiple servers, and
(c) a computer automation program connecting said build tool to said configuration management software tool for automatic extraction of said code, processing said code, and delivering to said servers.

11. A system as in claim 10 including a build server in which each of said configuration management tool, said build tool, and said automation program is stored on said build server.

12. A system as in claim 10 in which said build tool includes software for compiling said code, if necessary; creating build files from said code; converting said build files to proper communications protocol for transmission in said network, and sending said converted code to other network destinations.

13. A system as in claim 10 in which said build tool is an ANT build script utility.

14. A system as in claim 10 in which said configuration management tool includes states for development, integration, user acceptance testing and production of program code, and including a build master device for sequentially enabling said states.

15. A system as in claim 10 in which said build tool includes software for automatically notifying the parties at locations in said network that said build is completed.

16. A system for distributing code in a computer network, said system comprising:
(a) an integration software program for integrating said code for use on multiple servers in said network;
(b) a build software program for compiling code received from said integration program, if necessary; for building said code into a form usable in said servers; and converting said code to a transmission protocol and sending said code to said servers.

17. A system as in claim 16 including a build server in which both of said integration and build programs are stored.

18. A system as in claim 16 in which said integration software is one state in a configuration management program which includes at least one other state, and means for changing from one state to the next and repeating the operation of said build program for each separate state.

19. A system as in claim 16 including interface software for interfacing said integration program and said build program, including setting variables for the environment of said integration program; setting target build directories and script; setting environment path variables; and setting class paths for files.

20. A system as in claim 17 in which said integration program is a state of a configuration management program having at least one other state, and said interface software is formed as a user defined process in said configuration management program.

21. A computer-readable software storage medium, comprising:
(a) a configuration management program;
(b) a build program; and
(c) a program for operatively coupling said configuration management program and said build program to distribute program code to different locations in a computer network.

22. A storage medium as in claim 21 in which said build program includes software for compiling code from said configuration management program crating a build file, and converting code from said build file into a network transmission protocol, and sending said code to remote locations.
